(19) United States
(12) Patent Application Publication
(10) Pub. No.: US 2026/0322210 A1
(43) Pub. Date: Oct. 15, 2026

(54) OUTBOARD MOTOR BELT-DRIVE-TYPE ROTATING ELECTRIC MACHINE

(71) Applicant: MITSUBISHI ELECTRIC MOBILITY CORPORATION, Tokyo (JP)

(72) Inventors: Toshiaki KASHIHARA, Tokyo (JP); Keisuke SHIRAI, Tokyo (JP); Ririka TADA, Tokyo (JP)

(73) Assignee: MITSUBISHI ELECTRIC MOBILITY CORPORATION, Tokyo (JP)

(21) Appl. No.: 19/466,950

(22) Filed: Feb. 2, 2026

(30) Foreign Application Priority Data
Mar. 10, 2025 (JP) 2025-037224

(51) Int. Cl. H02K 7/10; B63H 20/14; H02K 5/20; H02K 9/06

(52) U.S. Cl. CPC H02K 7/1004; B63H 20/14; H02K 5/207; H02K 9/06

(57) ABSTRACT

Provided is an outboard motor belt-drive-type AC rotating electric machine in which belt wear powder is easily discharged to outside of the rotating electric machine to prevent rotation operation failure even in a state where the rotating electric machine is covered with a cowling and is not influenced by sailing wind. The outboard motor belt-drive-type AC rotating electric machine has a casing 4 in which a centrifugal fan 11A is provided. The centrifugal fan 11A is disposed to be opposed to an air intake port 2a, is rotated integrally with a rotor 8 on an upward direction side relative to the rotor 8, and has a plurality of blades. At least one of the plurality of blades protrudes to the upward direction side beyond a coil end 144 of a stator.

### FIELD OF THE INVENTION

The present disclosure relates to an outboard motor belt-drive-type rotating electric machine that is driven or performs drive by a belt.

### DESCRIPTION OF THE RELATED ART

For an outboard motor, an engine having a longitudinally-oriented crankshaft is employed, and motive force from the engine is transmitted to a pulley of a generator via a belt (see, for example, Patent Document 1).

### CITATION LIST

### Patent Document

Patent Document 1: Japanese Patent No. 4202586

### SUMMARY OF THE INVENTION

### Problem of the Invention

In the generator disclosed in the above Patent Document 1, the pulley is disposed in an upward direction. Consequently, a problem arises in that belt wear powder generated by wear through contact with the pulley falls and accumulates owing to the own weight to the inside from an upper slit (air intake port) provided on the upward direction side of a body (casing) of the generator so that rotation operation failure occurs.

The present disclosure has been made to solve the above problem, and an object of the present disclosure is to provide an outboard motor belt-drive-type rotating electric machine in which belt wear powder can be easily discharged to outside of the rotating electric machine and a coil end of a stator winding can be efficiently cooled so that rotation operation failure can be suppressed.

### MEANS TO SOLVE THE PROBLEM

An outboard motor belt-drive-type rotating electric machine according to the present disclosure is an outboard motor belt-drive-type rotating electric machine which is driven by an engine or drives the engine, the outboard motor belt-drive-type rotating electric machine including: a rotor fixed to a shaft; a stator enclosing an outer circumferential side of the rotor and having a stator core and a stator winding wound on the stator core; a casing holding the stator and supporting the shaft, the casing having an air intake port and an air discharge port respectively formed on an upward direction side and an outer circumferential side of the casing; a first centrifugal fan which is rotated integrally with the rotor to suction air from the air intake port into the casing and to discharge the air from the air discharge port to outside; and a pulley provided on a portion of the shaft that protrudes from the casing to an upward direction side, the pulley being connected to a crankshaft of an outboard motor via a belt, wherein the first centrifugal fan has a portion overlapping a coil end of the stator winding in a rotation axis direction and a portion protruding to the upward direction side beyond a top of the coil end.

### EFFECT OF THE INVENTION

In the outboard motor belt-drive-type rotating electric machine according to the present disclosure, belt wear powder can be efficiently discharged to outside and the coil end of the stator winding can be efficiently cooled so that rotation operation failure of the rotating electric machine can be suppressed.

### BRIEF DESCRIPTION OF THE DRAWINGS

FIG. 1 is a top view of a generator according to a first embodiment;

FIG. 2 is a cross-sectional view of the generator according to the first embodiment;

FIG. 3 is a cross-sectional view taken along the line A-A as seen in the direction of the arrows in FIG. 2;

FIG. 4 is a perspective view of a stator in the first embodiment;

FIG. 5 is a perspective view showing a continuous conductor wire composing a winding assembly of the stator in the first embodiment;

FIG. 6 is a perspective view showing a pair of continuous conductor wires composing the winding assembly of the stator in the first embodiment;

FIG. 7 is a perspective view of a rotor and centrifugal fans in the first embodiment;

FIG. 8 is a top view of a generator according to a second embodiment; and

FIG. 9 is a cross-sectional view showing the positional relationship of a rib in the second embodiment.

### DESCRIPTION OF EMBODIMENTS

### First Embodiment

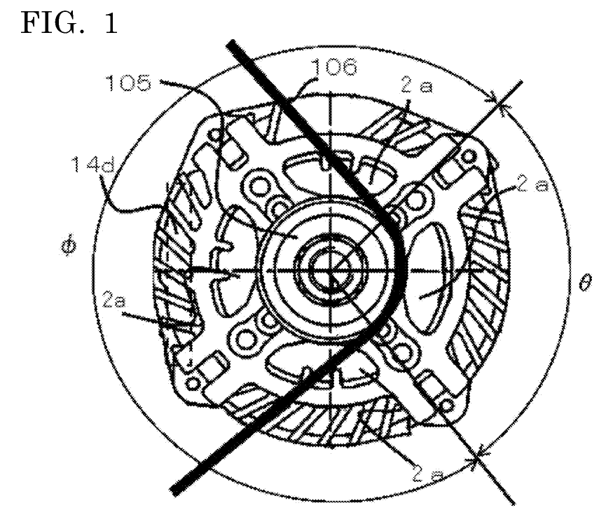

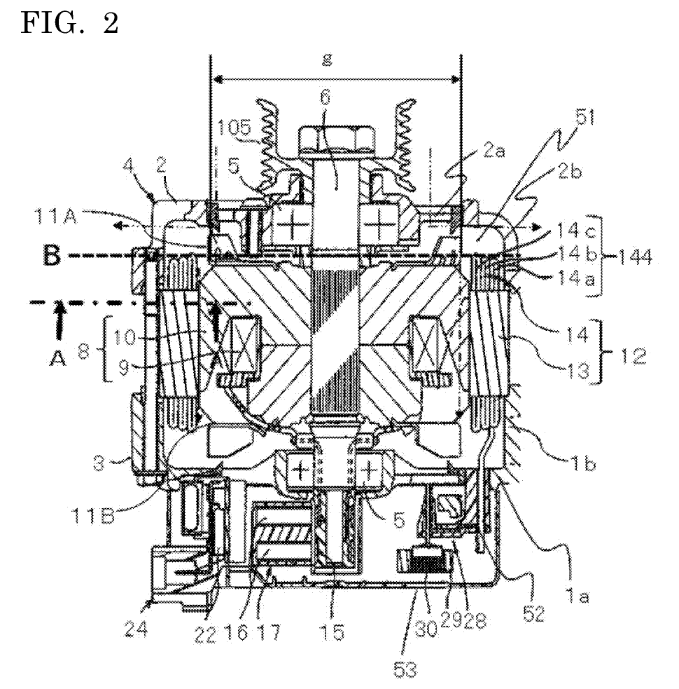

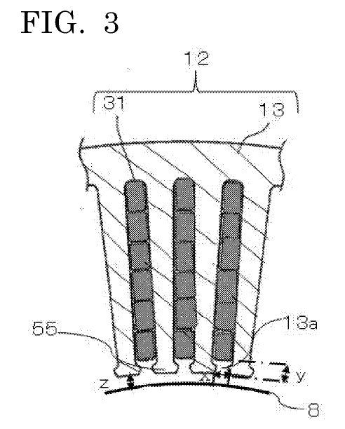

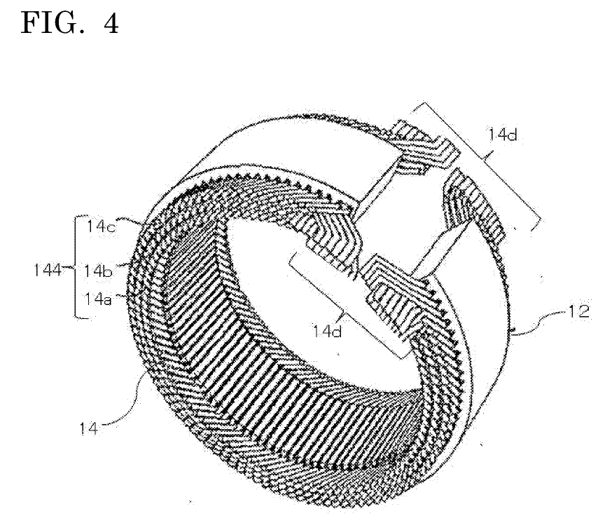

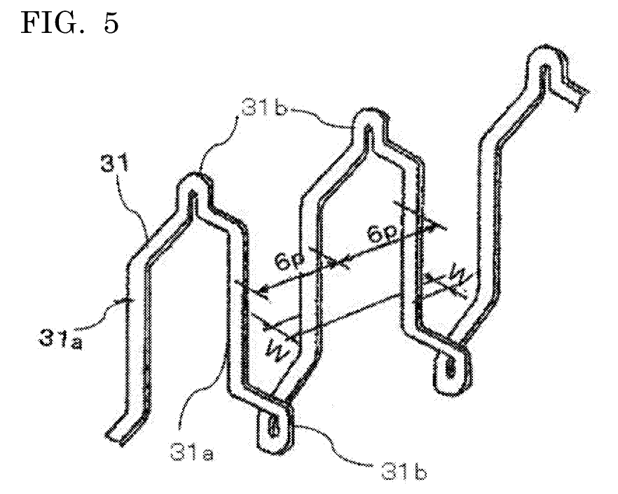

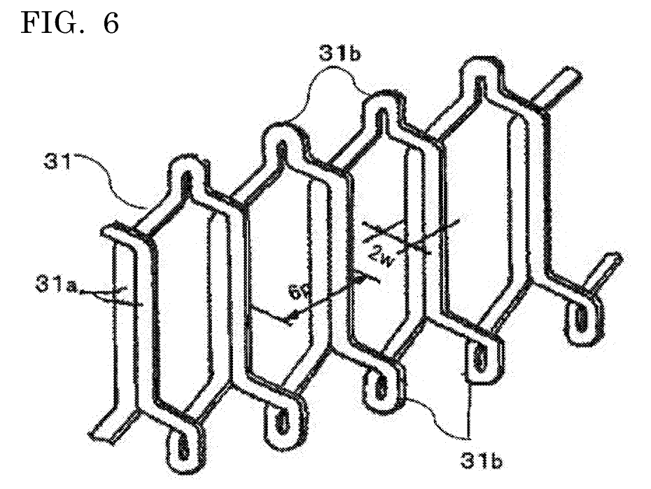

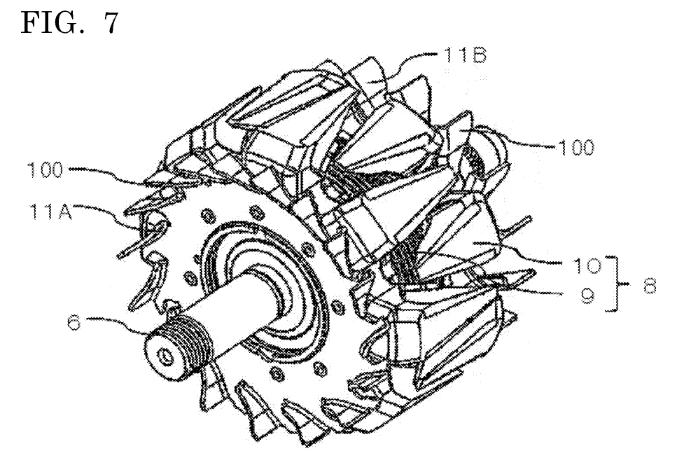

Hereinafter, an outboard motor belt-drive-type rotating electric machine according to a first embodiment of the present disclosure will be described. In the first embodiment, the outboard motor belt-drive-type rotating electric machine is a generator. FIG. 1 is a top view of the generator according to the first embodiment. FIG. 2 is a cross-sectional view of the generator according to the first embodiment. FIG. 3 is a cross-sectional view taken along A-A as seen in the direction of the arrows in FIG. 2. FIG. 4 is a perspective view of a stator in the first embodiment. FIG. 5 is a perspective view of a continuous conductor wire composing a winding assembly of the stator in the first embodiment. FIG. 6 is a perspective view showing a pair of continuous conductor wires composing the winding assembly of the stator in the first embodiment. FIG. 7 is a perspective view of a rotor and centrifugal fans in the first embodiment.

An outboard motor is configured such that an engine is longitudinally oriented, and a crankshaft is oriented substantially perpendicular thereto. In the outboard motor, a screw provided in a downward direction pushes out seawater rearward by rotation of blades and generates propulsive force frontward as a reaction to the pushing.

A generator is disposed parallel to the crankshaft inside an engine room of the outboard motor. A driving pulley is mounted on an upward direction side of the crankshaft, and the driving pulley and a driven pulley 105 of the generator are connected to each other via a belt 106. Such an outboard motor generator is ordinarily disposed such that a rotation axis thereof is oriented in the vertical direction (at 90 degrees). Alternatively, the outboard motor generator may be disposed such that this angle falls within a range from 45 degrees to 135 degrees.

A configuration of the generator according to the first embodiment will be described below. The generator according to the first embodiment is of a claw pole type. The generator has a casing 4 in which a rotor 8 fixed to a shaft 6 is accommodated. A stator 12 enclosing an outer circumference of the rotor 8 is held by the casing 4. The rotor 8 has a cylindrical shape, and a copper wire subjected to insulation treatment is cylindrically and concentrically wound thereon. The rotor 8 is composed of: a field winding 9 through which excitation current flows and from which a magnetic flux is generated; and a field core 10 provided to cover the field winding 9. The field core 10 is divided such that an upward direction side thereof and a downward direction side thereof have different magnetic poles. Each of the upward direction side and the downward direction side has eight claws. In the field core 10, the claws on the upward direction side and the claws on the downward direction side are set to be alternately shifted from each other at intervals in a rotation direction of the shaft 6.

The stator 12 is disposed to enclose the rotor 8 with a radial gap therebetween. A stator winding 14 through which AC current is generated owing to change in a magnetic flux from the field winding 9 in association with rotation of the rotor 8 is wound on a stator core 13 having a cylindrical shape.

As shown in FIG. 3, the stator winding 14 is formed by winding, on the stator core 13, continuous conductor wires 31 each of which is the continuous conductor wire 31 shown in FIG. 5. The stator core 13 has 96 teeth 55 having ends between which slot openings 13a are provided as shown in FIG. 3. Each of the slot openings 13a is a space penetrating in the upward and downward directions. In the present disclosure, the length in a circumferential direction of the slot opening 13a is defined as x, and the length in a radial direction between the radially innermost position of each of the teeth 55 and the radially innermost position of the stator winding 14 is defined as y. Also, the gap in the radial direction between the stator 12 and the rotor 8 is defined as a radial gap z. The radial gap z is set to 200 to 400 µm in consideration of balance between magnetic noise and power generation output. The length x in the circumferential direction is set to, for example, 2 mm in order to suppress magnetic flux leakage to a minimum level and form an efficient magnetic path. The length y in the radial direction is set to, for example, 2 mm in order to optimize the magnetic flux and absorb mechanical deformation without allowing mutual interference even when any of the teeth or the stator winding 14 bulges. Therefore, a structure is obtained in which the length x in the circumferential direction of the slot opening 13a and the length y in the radial direction between the radially innermost position of the tooth 55 and the radially innermost position of the stator winding 14 are larger than the dimension of the radial gap z.

Between every two of the teeth 55, six straight portions 31a (electrical conductors) of the continuous conductor wire 31 shown in FIG. 5 are arrayed side by side in one row in the radial direction to be aligned in a depth direction of a slot. When the continuous conductor wire 31 shown in FIGS. 5 and 6 reaches an end in an axial direction of the stator winding 14 in the course of winding the continuous conductor wire 31 on the stator core 13 shown in FIG. 3, the continuous conductor wire 31 is redirected and wound on the stator core 13 again. Portions at which this redirecting has been performed are turn portions 31b. As shown in FIG. 5, adjacent ones of the straight portions 31a are shifted from each other owing to the corresponding turn portion 31b by a width (w) of the continuous conductor wire 31 in a direction orthogonal to the array direction of the straight portions 31a. The continuous conductor wire 31 is wound to extend from one slot to an end surface side of the stator core 13, be turned back, and enter a slot that is away from the one slot by six slots (6p). Each of the continuous conductor wires 31 is wound to alternately occupy inner layers and outer layers in respective sixth slots (6p) in the depth direction (radial direction) of the slots. The pair of continuous conductor wires 31 shown in FIG. 6 is obtained by arraying continuous conductor wires 31 formed to extend to the end surface sides of the stator core 13 and to be turned back, such that: the continuous conductor wires 31 are shifted from each other by a pitch of six slots (6p); and the straight portions 31a are superposed to have a double width (2w). In this manner, the stator 12 is formed by arraying six such pairs of continuous conductor wires 31 such that each of the pairs is shifted by a pitch of one slot.

The stator winding 14 has coil ends 144 protruding from the end surfaces of the stator core 13. Each of the coil ends 144 has turn portions (shown in FIG. 4) which are implemented by the turn portions 31b shown in FIG. 5. As shown in FIG. 4, the turn portions of the coil end 144 are formed of a welded portion 14d subjected to insulation treatment and unwelded portions 14a, 14b, and 14c which ensure electrical connection and mechanical strength. As shown in FIG. 2, the unwelded portions 14a, 14b, and 14c of the coil end 144 are tilted such that heights thereof become lower in a radially outer direction from a position corresponding to an inner diameter. Also, the coil end 144 is configured such that a height thereof is lower at the unwelded portions 14a, 14b, and 14c than at the welded portion 14d. As shown in FIG. 1, the welded portion 14d is disposed outside (360°-θ=φ) of a range defined by a contact angle θ between contact surfaces of the driven pulley 105 and the belt 106.

As shown in FIG. 2, the casing 4 is composed of an upward-direction-side housing 2 and a downward-direction-side housing 3. The upward-direction-side housing 2 and the downward-direction-side housing 3 are fixed on the outer side of the stator 12 in the axial direction of the shaft 6 by using bolts. The stator 12 is, at both ends in the axial direction of the stator core 13, held by opening ends of the upward-direction-side housing 2 and the downward-direction-side housing 3. The casing 4 has bearings 5 on both respective sides in the axial direction of the shaft 6 and supports the shaft 6 via the bearings 5.

The upward-direction-side housing 2 is provided with: an air intake port 2a which is opposed to an end surface in the axial direction of the rotor 8 and into which cooling air is suctioned; and an air discharge port 2b which is located in an outer circumferential side surface and from which the cooling air is discharged. Similar to the upward-direction-side housing 2, the downward-direction-side housing 3 is also provided with: an air intake port 1a which is opposed to an end surface in the axial direction of the rotor 8 and into which cooling air is suctioned; and an air discharge port 1b which is located in an outer circumferential side surface and from which the cooling air is discharged. The air intake ports 1a and 2a and the air discharge ports 1b and 2b are opening portions divided by lattices or the like.

A slip ring 15 is provided to a portion of the shaft 6 that protrudes from the downward-direction-side housing 3 to the downward direction side. The portion of the shaft 6 that protrudes to the downward direction side and the downward direction side of the downward-direction-side housing 3 are covered with a protective cover 53.

A brush 16 which is slid on the surface of the slip ring 15, a brush holder 17 accommodating the brush 16, a voltage regulator 22 which regulates the magnitude of AC voltage generated by the stator 12, a rectifier 30 which rectifies the AC voltage generated by the stator 12 into DC voltage, and a heatsink 29 are provided between the protective cover 53 and the downward-direction-side housing 3.

The rectifier 30 includes: the heatsink 29 mounted with a plurality of positive-side rectifier elements and a plurality of negative-side rectifier elements; and a circuit board 28. The stator winding 14 of the stator 12 has a lead wire 52 led out from the downward-direction-side housing 3 into the protective cover 53 and connected to a terminal of the circuit board 28, whereby the rectifier 30 and the stator winding 14 are electrically connected to each other. The protective cover 53 has an outer circumference to which a connector 24 for inputting/outputting a signal between the voltage regulator 22 and an external device (not shown) is fixed.

The driven pulley 105 is fixed to a portion of the shaft 6 that protrudes from the upward-direction-side housing 2 to the upward direction side.

Inside the casing 4, a first centrifugal fan 11A and a second centrifugal fan 11B which are rotated integrally with the rotor 8 and which are respectively opposed to the air intake ports 2a and 1a of the casing 4 are provided. The first centrifugal fan 11A and the second centrifugal fan 11B are attached to both respective ends in the axial direction of the field core 10 of the rotor 8. The first centrifugal fan 11A is attached to the end surface on the upward direction side of the rotor 8 and is rotated integrally with the rotor 8. The second centrifugal fan 11B is attached to the end surface on the downward direction side of the rotor 8 and is rotated integrally with the rotor 8. Each of the first centrifugal fan 11A and the second centrifugal fan 11B has blades 100 disposed such that an outer diameter g defined by the blades 100 becomes smaller than an inner diameter of the stator 12. The first centrifugal fan 11A and the second centrifugal fan 11B do not have to be directly fixed to the rotor 8, and another member or a gap may be present between each of the centrifugal fans and the rotor 8 as long as rotation can be performed by rotation of the shaft 6.

FIG. 7 is a perspective view showing the rotor and the centrifugal fans. As shown in FIG. 7, for example, the first centrifugal fan 11A and the second centrifugal fan 11B have structures in which the blades 100 extending in all radial directions from the shaft 6 side are raised from the end surfaces in the axial direction of the field core 10 of the rotor 8.

Each of the first centrifugal fan 11A and the second centrifugal fan 11B is formed of a disc-shaped plate having, at the center thereof, a hole through which the shaft 6 is attached. The blades 100 of the first centrifugal fan 11A and the second centrifugal fan 11B are formed by cutting slits in the disc-shaped plate and bending portions of the plate along the slits.

In the present disclosure, as in FIG. 2, the first centrifugal fan 11A has at least one blade 100 having: a portion overlapping the corresponding coil end 144 in a rotation axis direction; and a portion protruding to the upward direction side beyond a top of the coil end 144. In other words, the at least one blade 100 is disposed to have: a portion having, in the axial direction, a height that is lower in the downward direction than the height of the broken line B in FIG. 2; and a portion having, in the axial direction, a height that is higher in the upward direction than the height of the broken line B in FIG. 2.

All of the blades 100 may have the same height in the rotation axis direction and may each have: a portion overlapping the corresponding coil end 144 in the rotation axis direction; and a portion protruding to the upward direction side beyond the top of the coil end 144. In other words, all of the blades 100 may each be disposed to have: a portion having, in the axial direction, a height that is lower in the downward direction than the height of the broken line B in FIG. 2; and a portion having, in the axial direction, a height that is higher in the upward direction than the height of the broken line B in FIG. 2. Alternatively, the first centrifugal fan 11A may be configured to have: a blade overlapping the corresponding coil end 144 in the rotation axis direction; and a blade protruding to the upward direction side beyond the top of the coil end 144. In other words, the first centrifugal fan 11A may be configured to have: a blade having, in the axial direction, a height that is lower in the downward direction than the height of the broken line B in FIG. 2; and a blade having, in the axial direction, a height that is higher in the upward direction than the height of the broken line B in FIG. 2.

In the present disclosure, the number of the blades 100 is 17, the number of the claws of the field core 10 is 16, and the number of the blades 100 and the number of the claws of the field core 10 are in a relationship of being coprime.

Next, operation of the generator will be described. A key switch is turned on, and the voltage regulator 22 detects a signal inputted to an indicator lamp terminal. Then, the voltage regulator 22 starts operation, and conduction through a power transistor (not shown) for supplying current to the field winding 9 is performed.

Initial excitation current flows from a battery (not shown) attached to the outboard motor to the field winding 9 incorporated in the rotor 8, whereby each of the claws of the field core 10 is excited. The excited rotor 8 is driven by the engine via the belt 106 from the driven pulley 105. A magnetic flux that passes through the stator winding 14 is changed by rotation of the rotor 8. This change in the magnetic flux causes induction of a voltage to the stator winding 14. When the generated voltage exceeds a battery terminal voltage, the own generated voltage is applied to the field winding 9 regardless of the initial excitation current from the battery, and a self-excited state is obtained.

The stator winding 14 generates an induction voltage owing to the change in the magnetic flux by the rotation of the rotor 8, and three-phase AC current flows. The three-phase AC current generated by the stator winding 14 is rectified into direct current by the rectifier 30 including the heatsink 29 mounted with the plurality of positive-side rectifier elements and the plurality of negative-side rectifier elements. The battery is charged with the direct current via an output terminal (not shown).

As described above, rotation from the engine is transmitted via the belt 106 to the driven pulley 105, and the rotor 8 is driven. By rotation of the rotor 8, the first centrifugal fan 11A and the second centrifugal fan 11B attached to both ends in the axial direction of the rotor 8 are rotated. The first centrifugal fan 11A and the second centrifugal fan 11B suction cooling air from the air intake ports 1a and 2a provided in the axial direction and discharge the cooling air from the air discharge ports 1b and 2b provided in the radial direction.

Cooling air suctioned through the air intake port 2a by the first centrifugal fan 11A which is rotated on the upward direction side relative to the rotor 8 is deflected in a centrifugal direction, cools the coil end 144 on the upward direction side, and is discharged to outside from the air discharge port 2b. Cooling air suctioned through the air intake port 1a by rotation of the second centrifugal fan 11B which is rotated on the downward direction side relative to the rotor 8 is deflected in the centrifugal direction, cools the coil end 144 on the downward direction side, and is discharged from the air discharge port 1b.

The flow of cooling air by each of the first centrifugal fan 11A and the second centrifugal fan 11B is generated not only in the centrifugal direction but also in the axial direction inside the generator. On the downward direction side of the generator, components that hinder the flow of the cooling air and that are exemplified by the brush 16, the slip ring 15, and the rectifier 30 are present, whereby the pressure and the air flow rate are low. Meanwhile, on the upward direction side of the generator, there is no component that hinders the flow of the cooling air, whereby the pressure is high and more air is sent out. As a result, the cooling air also flows from the upward direction side to the downward direction side owing to the difference in pressure between the upward direction side and the downward direction side. In a case where the number of blades 100 disposed to overlap the coil end 144 on the upward direction side in the axial direction among the blades 100 of the first centrifugal fan 11A is large, the air flow rate of cooling air generated in the axial direction becomes higher than in a case where the number of the blades 100 overlapping the coil end 144 in the axial direction is small.

The belt 106 attached to the driven pulley 105 of the generator has a surface in contact with the driven pulley 105. The surface might be worn. Thus, use and operation for a long time might lead to generation of belt wear powder having a particle diameter of about 50 to 200 µm. The angle at which such belt wear powder is easily generated is dependent on the contact angle θ between the belt 106 and the driven pulley 105. A larger contact angle θ leads to a larger contact area and further progression of wear.

In general, for example, a V-ribbed belt having a compressed rubber layer including cotton short fibers is used for the belt 106, and thus use thereof for a long time leads to generation of belt wear powder. As shown in FIG. 1, the belt 106 and the driven pulley 105 are in contact with each other within a range defined by the angle θ. This angle θ is referred to as the contact angle between the belt 106 and the driven pulley 105. Through the belt 106, motive force from the engine is transmitted via the driving pulley to the driven pulley 105, and belt wear powder is discharged owing to centrifugal force of the belt 106. The discharged belt wear powder enters the generator from the air intake port 2a on the upward direction side, freely falls owing to the own weight of the wear powder, and accumulates inside the generator.

In the present disclosure, the first centrifugal fan 11A which is rotated on the upward direction side relative to the rotor 8 is provided inside the upward-direction-side housing 2 of the generator, and the first centrifugal fan 11A is configured to have: a portion overlapping the corresponding coil end 144 in the rotation axis direction; and a portion protruding to the upward direction side beyond the top of the coil end 144.

Cooling air suctioned from the air intake port 2a on the upward direction side into the generator by the first centrifugal fan 11A is redirected in the centrifugal direction (to the radially outer side), cools the top of the coil end 144 on the upward direction side owing to the portion (blade 100) protruding to the upward direction side beyond the top of the coil end 144, and then is discharged from the air discharge port 2b. At this time, belt wear powder also enters the generator from the air intake port 2a by being carried in the flow of the above cooling air. However, since the first centrifugal fan 11A has the portion (blade 100) protruding to the upward direction side beyond the top of the coil end 144 on the upward direction side, the cooling air flowing in the centrifugal direction (on the radially outer side) while carrying the belt wear powder is caused to flow above the top of the coil end 144 on the upward direction side. Consequently, the belt wear powder can be discharged from the air discharge port 2b on the upward direction side. Therefore, an advantageous effect of suppressing rotation failure of the generator is exhibited.

Also, rotation of the portion (blade 100) of the first centrifugal fan 11A that is disposed to overlap the coil end 144 on the upward direction side in the axial direction causes the cooling air redirected in the centrifugal direction to come into direct contact with the inner wall surface of the coil end 144 on the upward direction side. Therefore, an advantageous effect of enhancing the cooling effect is exhibited. In addition, after the air flow generated by the blade 100 disposed to overlap the coil end 144 on the upward direction side in the axial direction comes into direct contact with the coil end 144 on the upward direction side, the air flow also advances from the upward direction side to the downward direction side. In other words, the cooling air having come into direct contact with the top of the coil end 144 on the upward direction side flows from the upward direction side to the downward direction side via the slot openings 13a along the straight portions 31a of the continuous conductor wires 31. Therefore, an advantageous effect of further enhancing the cooling effect on the inner side of the stator 12 is exhibited.

Furthermore, the number of the blades 100 and the number of the claws of the field core 10 are set to be coprime. Consequently, resonance is prevented from occurring at a rotational order corresponding to a common divisor. Therefore, an advantageous effect of enabling decrease in noise of the generator is exhibited. For example, in a case where the number of the blades 100 is 17 and the number of the claws is 16, the only common divisor of 17 and 16 is 1, and thus the likelihood of occurrence of resonance is decreased.

In addition, the first centrifugal fan 11A which is rotated on the upward direction side relative to the rotor 8 includes blades 100 protruding to the upward direction side from the top of the coil end 144 on the upward direction side, and these blades 100 have a structure in which the outer diameter g defined by the blades 100 is smaller than the inner diameter of the stator winding 14. Consequently, a space 51 which is provided in the upward-direction-side housing 2 and which is located on the upward direction side relative to the coil end 144 on the upward direction side shown in FIG. 2 serves as an air flow path of the first centrifugal fan 11A which is rotated on the upward direction side relative to the rotor 8. Therefore, an advantageous effect of enabling efficient cooling of the top of the coil end 144 on the upward direction side is exhibited.

The unwelded portions 14a, 14b, and 14c of the coil end 144 on the upward direction side have a tilted structure in which the heights thereof gradually become lower in the radially outer direction from the position corresponding to the inner diameter. Consequently, the air flow path of the first centrifugal fan 11A which is rotated on the upward direction side relative to the rotor 8 is widened. Therefore, an advantageous effect of efficiently discharging belt wear powder to the air discharge port 2b is exhibited. It becomes easy for the cooling air discharged in the centrifugal direction to be evenly spread to the coil end 144 having the tilted structure. Therefore, an advantageous effect of enabling efficient suppression of increase in the temperature of the stator winding 14 is exhibited. In addition, a configuration is employed in which: the continuous conductor wires 31 of the stator winding 14 are arrayed in one row in the radial direction inside a slot; and the number of the continuous conductor wires 31 inside the slot is 2n (n represents a natural number). Consequently, the number of joining locations for producing the stator winding 14 is significantly decreased. Therefore, an advantageous effect of facilitating manufacturing of the stator 12 is exhibited.

Each of the unwelded portions 14a, 14b, and 14c of the coil end 144 have a structure in which the unwelded portion has a lower height than the welded portion 14d. Consequently, the space 51 which is provided in the upward-direction-side housing 2 and which is an exit passage for belt wear powder is expanded, and the probability of collision between belt wear powder and the inner wall surface of the coil end 144 is decreased. Therefore, an advantageous effect of enabling efficient discharge of belt wear powder to the air discharge port 2b is exhibited.

Belt wear powder is easily generated within the range defined by the contact angle θ between the contact surfaces of the driven pulley 105 and the belt 106. Considering this, the welded portion 14d is disposed within a range (360°-θ=φ) defined by an exterior angle corresponding to the contact angle θ. Consequently, an advantageous effect of enabling efficient flow of air discharged from the first centrifugal fan 11A which is rotated on the upward direction side relative to the rotor 8 and enabling discharge of belt wear powder to the air discharge port 2b is exhibited within the range which is defined by the interior angle (i.e., the contact angle θ) and within which belt wear powder is easily generated.

Dimensions in the circumferential direction and the radial direction of each of the slot openings 13a are set to be larger than the radial gap z between the stator 12 and the rotor 8. Consequently, the following advantageous effect is exhibited. That is, even in a case where belt wear powder falls in the downward direction owing to the own weight, the second centrifugal fan 11B on the downward direction side discharges the belt wear powder to the air discharge port 1b by carrying the belt wear powder in the flow of cooling air discharged in the centrifugal direction, whereby rotation failure of the generator can be suppressed.

A configuration is employed in which a rate of an air flow on the upward direction side generated by the first centrifugal fan 11A is higher than a rate of an air flow on the downward direction side generated by the second centrifugal fan 11B so that cooling air flows through the slot openings 13a from the upward direction side to the downward direction side. Consequently, the following advantageous effect is exhibited. That is, even in a case where belt wear powder cannot be discharged from the air discharge port 2b and falls in the downward direction, the second centrifugal fan 11B on the downward direction side discharge the belt wear powder to the air discharge port 1b by carrying the belt wear powder in the flow of cooling air discharged in the centrifugal direction, whereby rotation failure of the generator can be suppressed.

### Second Embodiment

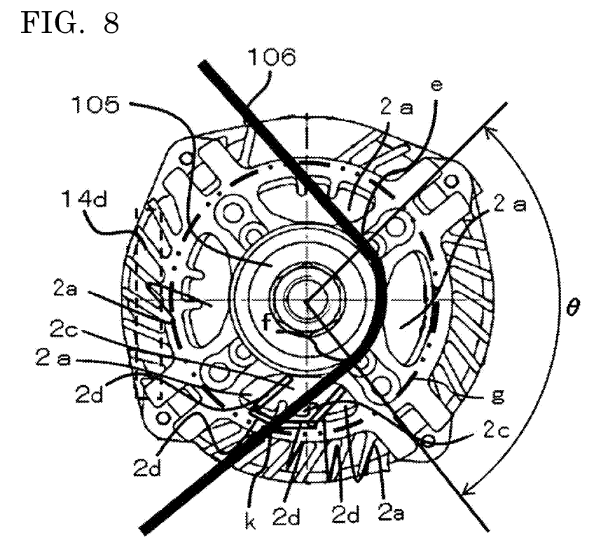

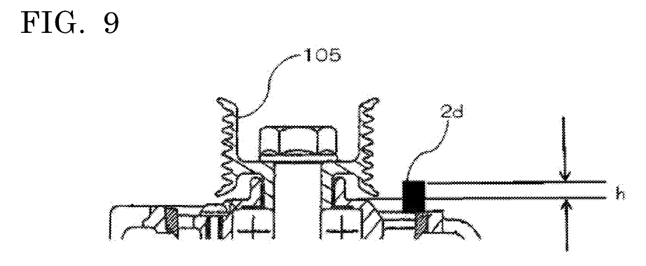

A generator according to a second embodiment will be described with reference to FIGS. 8 and 9. In FIG. 8, the same or corresponding portions are denoted by the same reference characters as those in FIG. 1. FIG. 9 is an upper part of the cross-sectional view of the generator in FIG. 2 and does not show the internal structure of the generator. In FIG. 8, the belt 106 is rotated clockwise and comes into contact with the driven pulley 105 of the generator, whereby the driven pulley 105 is rotated clockwise. Here, a point at which the driven pulley 105 starts to be in contact with the belt 106 for the first time as a result of being rotated and approaching the belt 106 is referred to as a belt contact start point e. Meanwhile, a point at which the driven pulley 105 eventually starts to be away from the belt 106 as a result of being rotated and being separated from the belt 106 is referred to as a belt contact end point f. In the first embodiment, the air intake port 2a (FIG. 1) in the casing 4 is entirely opened. Meanwhile, in the second embodiment, the air intake port 2a in the casing 4 is provided with a closed region 2c. The closed region 2c of the air intake port 2a blocks belt wear powder within a straight section connecting the belt contact end point to an intersection k between the belt 106 and a projected first fan radially outer edge g. A point at which a largest amount of belt wear powder is generated within the straight section connecting the belt contact end point f to the intersection k between the belt 106 and the projected first fan radially outer edge g is the belt contact end point f. In the second embodiment, the straight section connecting the belt contact end point f to the intersection k between the belt 106 and the projected first fan radially outer edge g is referred to as a wear powder accumulation portion. As shown in FIG. 9, the driven pulley 105 and a rib 2d overlap each other by a distance h in the rotation axis direction.

Similar to the generator according to the first embodiment, the generator according to the second embodiment which is thus configured also has the following feature. That is, since the air intake port 2a is partially present, discharge to the air discharge port 2b can be efficiently performed by cooling air suctioned from the air intake port 2a by the first centrifugal fan 11A which is rotated on the upward direction side relative to the rotor 8. Furthermore, in the second embodiment, although belt wear powder is discharged owing to centrifugal force of the belt 106 from an open space present between the driven pulley 105 and the belt 106, since the closed region 2c is provided in a part of the air intake port 2a, an advantageous effect of preventing belt wear powder from entering the generator is exhibited. The closed region 2c of the air intake port 2a can prevent belt wear powder from entering the generator, only within a range immediately below the straight section connecting the belt contact end point f to the intersection k between the belt 106 and the projected first fan radially outer edge g, and a small amount of belt wear powder adhered on a portion outside of the fan radially outer edge falls off. However, the outer circumferential side of this portion is provided with the air discharge port 1b through which the belt wear powder is blown away, whereby the belt wear powder can be prevented from entering the generator. The belt 106 oscillates owing to rotational vibration. Considering this, the closed region 2c of the air intake port 2a may be formed to have a predetermined width from a center line which is defined as a straight line connecting the belt contact end point f to the intersection k between the belt 106 and the projected first fan radially outer edge g. Also, as shown in FIG. 9, the driven pulley 105 and the rib 2d overlap each other by the distance h in the rotation axis direction. The distance h indicates the distance from one end of the driven pulley 105 to the rib 2d. The casing 4 is, at a portion thereof near the belt contact end point f, provided with the rib 2d. Consequently, since the point at which the largest amount of belt wear powder is generated within the straight section connecting the belt contact end point f to the intersection k between the belt 106 and the projected first fan radially outer edge g is the belt contact end point f, an advantageous effect of further preventing entry of belt wear powder discharged from the open space between the driven pulley 105 and the belt 106 owing to centrifugal force of the belt 106 is exhibited. The portion near the belt contact end point f only has to include at least a small space in which at least the belt 106 and the rib 2d are not in contact with each other. From the viewpoint of preventing intake, this portion only has to be on the inner side relative to the projected first fan radially outer edge g. A plurality of the ribs 2d may be provided on the periphery of the closed region 2c of the air intake port 2a. By providing the ribs 2d on the periphery of the closed region of the air intake port 2a, belt wear powder can be prevented from entering the air discharge port 2b and the air intake port 2a. Belt wear powder can be accumulated by wall surfaces having heights equal to the distance h to the ribs 2d. Thus, during maintenance of the generator, removal of the generator from the outboard motor can be easily performed such that entry into the air discharge port 1b does not occur.

### Third Embodiment

A generator according to a third embodiment will be described with reference to FIG. 2. The first centrifugal fan 11A according to the first embodiment has a portion overlapping the corresponding coil end 144 in the rotation axis direction and a portion protruding to the upward direction side beyond the top of the coil end 144. Meanwhile, a first centrifugal fan 11A according to the third embodiment has a configuration in which all of the blades 100 protrude to the upward direction side beyond the top of the coil end 144. In other words, all of the blades 100 are each formed to have, in the axial direction, a height that is higher in the upward direction than the height of the broken line in FIG. 2.

Similar to the generator according to the first embodiment, the generator according to the third embodiment which is thus configured has the following feature. That is, cooling air suctioned from the air intake port 2a on the upward direction side into the generator by the first centrifugal fan 11A is redirected in the centrifugal direction (to the radially outer side) and cools the top of the coil end 144 on the upward direction side owing to the portion (blade 100) protruding to the upward direction side beyond the top of the coil end 144. In addition, belt wear powder can be efficiently discharged to the air discharge port 2b by carrying the belt wear powder in the cooling air suctioned from the air intake port 2a. Furthermore, in the third embodiment, all of the blades 100 of the first centrifugal fan 11A are formed to protrude to the upward direction side beyond the top of the coil end 144, whereby the air flow rate in the air flow path from the air intake port 2a to the air discharge port 2b becomes higher than in the first embodiment. Therefore, an advantageous effect of more efficiently discharging belt wear powder from the air discharge port 2b is exhibited.

Although a generator to be driven by a belt has been described above as an example in each of the first to third embodiments, the product to which the present disclosure is applicable is not limited to such a generator, and the present disclosure is also applicable to a rotating electric machine including an electric motor to be driven by a belt. The rotating electric machine may be an electrically-powered generator having functions of both the electric motor and the generator. With such products as well, the problem of the present disclosure arises, and the first to third embodiments are applied.

### DESCRIPTION OF THE REFERENCE CHARACTERS

2a air intake port

2b air discharge port

2d rib

e belt contact start point

f belt contact end point

g projected first fan radially outer edge

k intersection between belt and projected first fan radially outer edge

4 casing

8 rotor

11A centrifugal fan to be rotated on upward direction side relative to rotor

11B centrifugal fan to be rotated on downward direction side relative to rotor

12 stator

13a slot opening

144 coil end

14a, 14b, 14c unwelded portion

14d welded portion

z radial gap

31 continuous conductor wire

31b turn portion

55 tooth

100 blade

105 driven pulley

1. An outboard motor belt-drive-type rotating electric machine which is driven by an engine or drives the engine, the outboard motor belt-drive-type rotating electric machine comprising:
a rotor fixed to a shaft;
a stator enclosing an outer circumferential side of the rotor and having a stator core and a stator winding wound on the stator core;
a casing holding the stator and supporting the shaft, the casing having an air intake port and an air discharge port respectively formed on an upward direction side and an outer circumferential side of the casing;
a first centrifugal fan which is rotated integrally with the rotor to suction air from the air intake port into the casing and to discharge the air from the air discharge port to outside; and
a pulley provided on a portion of the shaft that protrudes from the casing to an upward direction side, the pulley being connected to a crankshaft of an outboard motor via a belt, wherein
the first centrifugal fan has
a portion overlapping a coil end of the stator winding in a rotation axis direction and
a portion protruding to the upward direction side beyond a top of the coil end.

2. The outboard motor belt-drive-type rotating electric machine according to claim 1, wherein
the first centrifugal fan has a plurality of blades, and
an outer diameter defined by the blades is smaller than an inner diameter of the coil end.

3. The outboard motor belt-drive-type rotating electric machine according to claim 1, wherein
the stator winding is formed of continuous conductor wires and arrayed in one row in a radial direction inside a slot of the stator core, and
the number of the continuous conductor wires inside the slot is 2n (n represents a natural number).

4. The outboard motor belt-drive-type rotating electric machine according to claim 1, wherein
the coil end has a turn portion formed of a welded portion and an unwelded portion, and
the unwelded portion is tilted to gradually become lower in a radially outer direction.

5. The outboard motor belt-drive-type rotating electric machine according to claim 2, wherein
the coil end has a turn portion formed of a welded portion and an unwelded portion, and
the unwelded portion is tilted to gradually become lower in a radially outer direction.

6. The outboard motor belt-drive-type rotating electric machine according to claim 3, wherein
the coil end has a turn portion formed of a welded portion and an unwelded portion, and
the unwelded portion is tilted to gradually become lower in a radially outer direction.

7. The outboard motor belt-drive-type rotating electric machine according to claim 1, wherein
the coil end has a turn portion formed of a welded portion and an unwelded portion, and
the unwelded portion has a lower height than the welded portion.

8. The outboard motor belt-drive-type rotating electric machine according to claim 2, wherein
the coil end has a turn portion formed of a welded portion and an unwelded portion, and
the unwelded portion has a lower height than the welded portion.

9. The outboard motor belt-drive-type rotating electric machine according to claim 3, wherein
the coil end has a turn portion formed of a welded portion and an unwelded portion, and
the unwelded portion has a lower height than the welded portion.

10. The outboard motor belt-drive-type rotating electric machine according to claim 1, wherein
the coil end has a turn portion formed of a welded portion and an unwelded portion, and
the welded portion is disposed outside of a range defined by a contact angle between the pulley and the belt.

11. The outboard motor belt-drive-type rotating electric machine according to claim 2, wherein
the coil end has a turn portion formed of a welded portion and an unwelded portion, and
the welded portion is disposed outside of a range defined by a contact angle between the pulley and the belt.

12. The outboard motor belt-drive-type rotating electric machine according to claim 3, wherein
the coil end has a turn portion formed of a welded portion and an unwelded portion, and
the welded portion is disposed outside of a range defined by a contact angle between the pulley and the belt.

13. The outboard motor belt-drive-type rotating electric machine according to claim 1, wherein
the stator has teeth between which slot openings penetrating in an axial direction of the rotor are provided, and
dimensions in a circumferential direction and a radial direction of each of the slot openings are larger than a radial gap which is a gap between the stator and the rotor.

14. The outboard motor belt-drive-type rotating electric machine according to claim 13, further comprising
a second centrifugal fan which is rotated integrally with the rotor on a downward direction side relative to the rotor, wherein
an air flow rate in the first centrifugal fan is higher than an air flow rate in the second centrifugal fan.

15. The outboard motor belt-drive-type rotating electric machine according to claim 1, wherein
the air intake port is provided within a range excluding a range immediately below a wear powder accumulation portion connecting a belt contact end point to an intersection between the belt and a radially outer edge of the first centrifugal fan having been projected.

16. The outboard motor belt-drive-type rotating electric machine according to claim 15, wherein
the casing is provided with a rib between the wear powder accumulation portion and the air intake port or the air discharge port, and
the pulley and the rib overlap each other in the rotation axis direction.

17. An outboard motor belt-drive-type rotating electric machine which is driven by an engine or drives the engine, the outboard motor belt-drive-type rotating electric machine comprising:
a rotor fixed to a shaft;
a stator enclosing an outer circumferential side of the rotor and having a stator core and a stator winding wound on the stator core;
a casing holding the stator and supporting the shaft, the casing having an air intake port and an air discharge port respectively formed on an upward direction side and an outer circumferential side of the casing;
a first centrifugal fan which is rotated integrally with the rotor to suction air from the air intake port into the casing and to discharge the air from the air discharge port to outside; and
a pulley provided on a portion of the shaft that protrudes from the casing to an upward direction side, the pulley being connected to a crankshaft of an outboard motor via a belt, wherein
the first centrifugal fan has a plurality of blades, and
all of the plurality of blades are each composed only of a portion protruding to the upward direction side beyond a top of a coil end of the stator winding.
